(19) United States
(12) Patent Application Publication
(10) Pub. No.: US 2012/0227890 A1
(43) Pub. Date: Sep. 13, 2012

(54) FRICTION STIR WELDING METHOD AND WELDING JIG USED THEREFOR

(75) Inventors: Ryo YAMAUCHI, Shizuoka-Ken (JP); Kentaro KOBARI, Shizuoka-Ken (JP)

(73) Assignee: SUZUKI MOTOR CORPORATION, Shizuoka-Ken (JP)

(21) Appl. No.: 13/411,966

(22) Filed: Mar. 5, 2012

(30) Foreign Application Priority Data
Mar. 7, 2011 (JP) 2011-049000

(51) Int. Cl. B29C 65/06; B23K 20/12

(52) U.S. Cl. 156/73.5; 228/112.1; 228/2.1; 156/538

(57) ABSTRACT

A friction stir welding performed by preparing a pair of members to be welded, each including an abutment surface and a margin portion provided in an extended manner, the margin portion including a welding surface that is continuous to the abutment surface by using a welding tool for performing friction stir welding. The welding tool integrally includes a columnar shoulder portion and a probe portion formed on a leading end surface of the shoulder portion, the probe portion having a diameter smaller than a diameter of the shoulder portion. The abutment surfaces and the welding surfaces are brought into contact with each other so as to form a continuous welding line therebetween.

### PRIORITY CLAIM

This patent application claims priority to Japanese Patent Application No. 2011-049000, filed 7 Mar. 2011, the disclosures of which is incorporated herein by reference in its entirety.

### BACKGROUND

1. Field

Disclosed embodiments relate to a friction stir welding method (method of performing friction stir welding) and a welding jig used for the method.

2. Related Art

A friction stir welding (FSW) method is a method, as shown in FIGS. 16 and 17, of welding members 101 and 102 to be welded together, and in the method, a rotating welding tool 103 is moved while being pressed against members to be welded 101 and 102 (which may be called merely “the members 101 and 102” hereinafter) are then softened by frictional heat generated between the welding tool 103 and the members 101 and 102. Then, the members to be welded 101 and 102 are joined to each other by solid-phase welding manner utilizing a plastic flow behavior caused by the rotation of the welding tool 103.

The friction stir welding is performed under a low heat input, and accordingly, different from general welding method, thermal strain and reduction in strength of a base material are advantageously less caused to a friction stir welding portion 104.

In normal friction stir welding, unfortunately, due to welding principle thereof and the shape of the welding tool 103, an unwelded portion 105 remains in a welded body 100, and a tool hole 106 (FIG. 18) made by the welding tool 103 also remains at a welding end point. This face may reduce the strength of the welded body 100.

To address this problem, as illustrated in FIG. 19 and FIG. 20 and also as disclosed in Japanese Patent Laid-Open No. 10-71477, margin portions 107 (end tabs) are provided in an extended manner to respective ends of the members to be welded 101 and 102, friction stir welding (FSW) is performed with the margin portions 107 serving as the welding end point, and the margin portions 107 are cut off along a cutoff line 108 after the welding. According to this method, the unwelded portion 105 can be prevented from remaining, and a product 110 such as shown in FIG. 21, which does not include the tool hole 106, would be obtained by cutting off the margin portions 107 including the tool hole 106.

Unfortunately, however, in the case where the members 101 and 102 formed with the margin portions 107 are joined to each other by the friction stir welding, each margin portion 107 needs to support a pressing load applied by the welding tool 103, and it is hence necessary to increase the size of the margin portion 107 in order to secure the rigidity of the margin portion 107. Accordingly, as illustrated in FIG. 21A and FIG. 21B, an area of a margin cutoff surface 109 formed by cutting off the margin portions 107 becomes large, thus being disadvantageous.

Moreover, the external appearance of the margin cutoff surface 109 is different from that of the other portion of the surface of the product 110, resulting in a decrease in the quality of external appearance of the product 110. Particularly, in the case where the product 110 is used for, for example, a frame of a motorcycle that is required to provide fine appearance, such a decrease in the quality of the external appearance will lead to a significant problem.

### SUMMARY

Disclosed embodiments provide a method of friction stir welding and also provide a welding jig capable of reducing a cutoff area of margin portions to enhance the quality of the external appearance of a product and reliably preventing a welding failure of members to be welded due to deformations of the margin portions.

One disclosed embodiments provides a friction stir welding method, comprising: preparing a pair of members to be welded each including an abutment surface and a margin portion provided in an extended manner, the margin portion including a welding surface that is continuous to the abutment surface; preparing a welding tool for performing friction stir welding, the welding tool integrally including a columnar shoulder portion and a probe portion formed on a leading end surface of the shoulder portion, the probe portion having a diameter smaller than a diameter of the shoulder portion; bringing the abutment surfaces into contact with each other, bringing the welding surfaces into contact with each other, and holding the members to be welded so as to form a continuous welding line therebetween; setting, under the state, a load supporting jig portion on a bottom surface side of a pair of the margin portions while setting a deformation restricting jig portion on a top surface side of the pair of margin portions, the load supporting jig portion supporting a pressing load applied by the welding tool, the deformation restricting jig portion restricting deformations of the margin portions toward the top surfaces thereof; and pressing the welding tool against top surfaces of the members to be welded while rotating the welding tool, and moving the welding tool along the welding line until the welding tool reaches the margin portions to thereby join the members to be welded to each other and join the margin portions to each other by the friction stir welding.

In another disclosed embodiment, there is also provided a welding jig used for a friction stir welding method, the friction stir welding method including the steps mentioned above, the welding jig comprising: a load supporting jig portion; and a deformation restricting jig portion, wherein the load supporting jig portion is set on a bottom surface side of a pair of the margin portions for supporting a pressing load applied by the welding tool, and the deformation restricting jig portion is set to on a top surface side of the pair of margin portions for restricting deformations of the margin portions toward the top surfaces thereof.

According to the friction stir welding method and the welding jig, the welding tool is pressed and moved along the welding line between the members to be welded and between the margin portions while being rotated, whereby the members to be welded are joined to each other and the margin portions are joined to each other by the friction stir welding. On this occasion, the load supporting jig portion supports the pressing load that is applied by the welding tool to the margin portions. As a result, cross-sectional areas of the margin portions can be reduced, and the margin portions can be thus downsized, so that a cutoff area formed by cutting off the margin portions can be made smaller. Accordingly, the quality of the external appearance of a product can be enhanced.

Furthermore, according to the disclosed embodiments, since the welding tool is pressed and moved along the welding line between the members to be welded and between the margin portions while being rotated, the members to be welded are joined to each other and the margin portions are joined to each other by the friction stir welding. On this occasion, the deformation restricting jig portion restricts the deformations of the margin portions toward the top surfaces thereof, that is, an uplifting deformation of the margin portions and an associated opening deformation of the welding surfaces of the margin portions. As a result, lack in material due to the opening deformation of the welding surfaces of the margin portions can be avoided. Accordingly, a welding failure of the members to be welded due to the deformations of the margin portions can be reliably prevented, thus being convenient and advantageous.

The nature and further characteristic features of the present invention will be made clearer from the following descriptions made with reference to the accompanying drawings.

### BRIEF DESCRIPTION OF THE DRAWINGS

In the accompanying drawings:

FIG. 1 is a perspective view illustrating a pair of members to be welded used in one disclosed embodiment of a friction stir welding (FSW) method;

FIG. 2 is a side view illustrating a welding tool for performing the friction stir welding on the members to be welded in FIG. 1;

FIG. 3 is a cross-sectional side view illustrating a situation where the friction stir welding is being performed on the members to be welded in FIG. 1;

FIG. 4 is a plan view illustrating the situation where the friction stir welding in FIG. 3 is being performed;

FIG. 5 (including FIGS. 5A, 5B and 5C) is a cross-sectional front view illustrating a sectional shape of a margin portion of the members to be welded in FIG. 1 together with a load supporting jig portion;

FIG. 6 represents a state where the margin portions are cut off from a welded body after the end of the friction stir welding in FIG. 3, in which FIG. 6A is a sectional side view, and FIG. 6B is a front view;

FIG. 7 is a table representing welding conditions of the friction stir welding in FIG. 3;

FIG. 8 is a sectional side view illustrating a situation where the friction stir welding is being performed using a welding jig not including a deformation restricting jig portion;

FIG. 9 is a plan view illustrating the situation where the friction stir welding in FIG. 8 is being performed;

FIG. 10 is a picture showing a side view of welding state of a welded body after the friction stir welding in FIG. 8 is performed under the welding conditions in FIG. 7;

FIG. 11 is a picture showing the welded body in FIG. 10 taken obliquely from an upper side;

FIG. 12 is a picture showing a side view of a welding state of a welded body after the friction stir welding in FIG. 3 is performed under the welding conditions in FIG. 7;

FIG. 13 is a picture showing a side view of the welded body in FIG. 12 taken obliquely from the upper side;

FIG. 14 is a picture showing a front side of the welded body in FIG. 12;

FIG. 15 is a sectional side view illustrating a situation where the friction stir welding is being performed using another example deformation restricting jig portion of the welding jig illustrated in FIG. 3;

FIG. 16 is a sectional side view illustrating a situation where a friction stir welding is being performed according to a conventional method;

FIG. 17 is a plan view illustrating the situation where the friction stir welding in FIG. 16 is being performed;

FIG. 18 is a sectional side view illustrating a state after the end of the friction stir welding in FIG. 16;

FIG. 19 is a sectional side view illustrating a situation where the friction stir welding is being performed according to another conventional method;

FIG. 20 is a plan view illustrating the situation where the friction stir welding in FIG. 19 is being performed; and

FIG. 21 illustrates a state where a margin portion is cut off from a welded body after the end of the friction stir welding in FIG. 19, in which FIG. 21A is a sectional side view and FIG. 21B is a front view.

### DESCRIPTION OF THE DISCLOSED EMBODIMENTS

Disclosed embodiments will be described with reference to the accompanying drawings. It is further noted that the present invention is not limited to the embodiments disclosed hereunder.

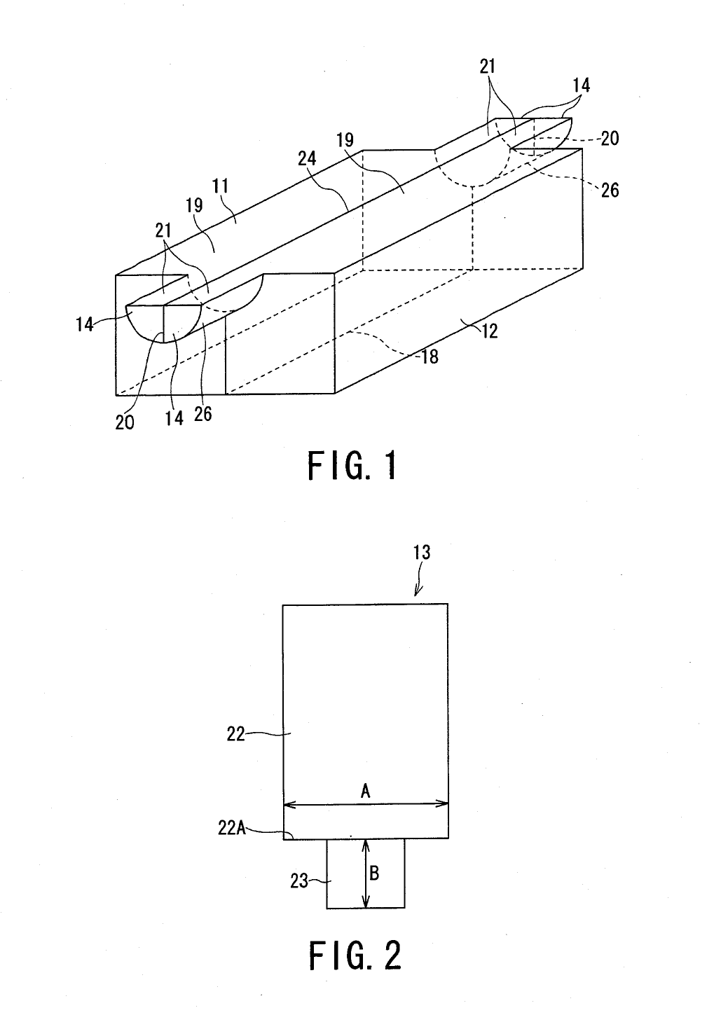

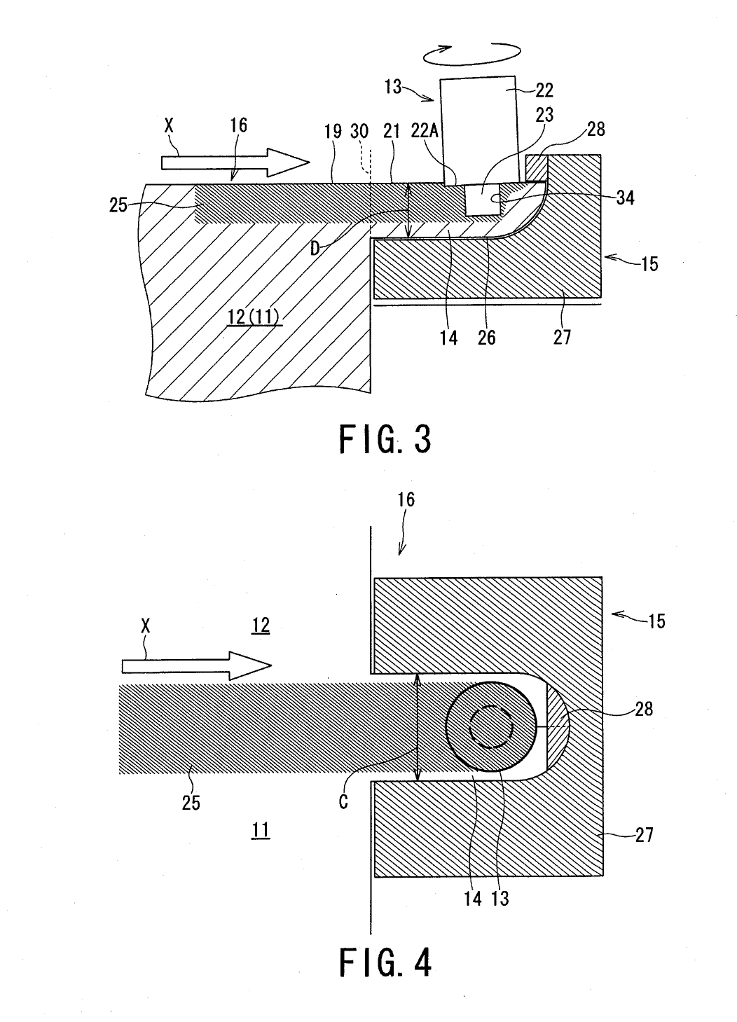

With reference to FIGS. 1 to 3, illustrating a pair of members to be welded by a friction stir welding (FSW) method, the friction stir welding is performed by using a welding tool shown in FIG. 2 in a state shown in FIG. 3.

The friction stir welding illustrated in FIG. 3 is the following method for joining. That is, a pair of members to be welded 11 and 12 (FIG. 1) are softened by frictional heat generated between the members to be welded 11 and 12 and a rotating welding tool 13 (FIG. 2) without being melted, and the members to be welded 11 and 12 are joined to each other by solid-phase welding with the utilization of a plastic flow behavior caused by the rotation of the welding tool 13 (the members to be welded 11 and 12 may be called hereinafter merely members 11 and 12).

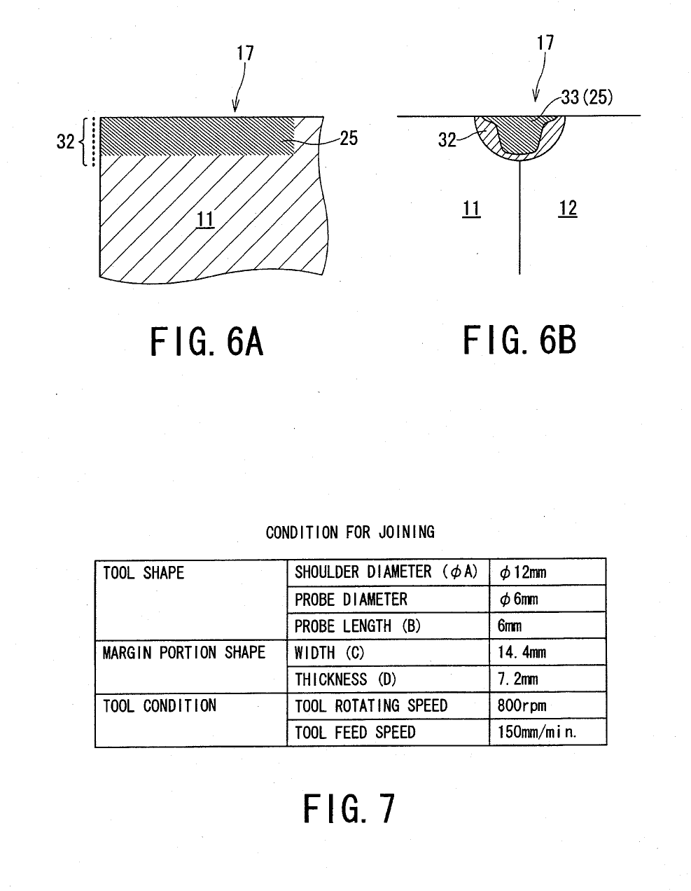

In an actual friction stir welding operation, specifically, the pair of members to be welded 11 and 12 each provided with a margin portion 14 (FIG. 1) in an extended manner and the welding tool 13 (FIG. 2) are prepared. The pair of members 11 and 12 are then held so as to abut against each other. In this state, a welding jig 15 (FIG. 3) is set along the respective margin portions 14 of the members 11 and 12. Thereafter, the welding tool 13 is pressed and moved against the members to be welded 11 and 12 while being rotated. In this way, the friction stir welding is performed to obtain a welded body 16 such as shown in FIG. 4. After the friction stir welding, the margin portions 14 are cut off from the welded body 16 to obtain a product 17 as shown in FIG. 6.

The members to be welded 11 and 12 illustrated in FIG. 1 are each provided with an abutment surface 18 and a flat top surface 19. The members 11 and 12 are made of materials that allow the friction stir welding, for example, an aluminum alloy; a magnesium alloy; a copper alloy; a steel material; aluminum, magnesium, titanium and an alloy thereof as matrix metal; and a metal-based composite material containing fibers and particles as a reinforcing material. Furthermore, the members to be welded 11 and 12 may be made of the same material or may be made of different materials.

The members to be welded 11 and 12 are each provided with the margin portion 14 extended outward, and the margin portion 14 is provided with a welding surface 20 that is continuous with the abutment surface 18 of each of the respective members 11 and 12. In addition, the margin portion 14 is provided with a flat top surface 21 that is continuous with the top surface 19 of each of the members 11 and 12.

The margin portion 14 may be formed integrally with each of the members 11 and 12, or may be formed separately and fixed to each of the members 11 and 12 by welding means, by a fastener, or by the other suitable methods.

As illustrated in FIG. 2, the welding tool 13 is integrally provided with a columnar shoulder portion 22 and a probe portion 23 formed on a leading end surface 22A of the shoulder portion 22. The probe portion 23 is formed so as to have a diameter smaller than that of the shoulder portion 22 to be coaxial with the shoulder portion 22. The welding tool 13 is rotationally driven by a driving shaft, not shown, at the time of performing the friction stir welding.

At the time of the rotation of the welding tool 13, the leading end surface 22A of the shoulder portion 22 is pressed against the top surfaces 19 of the members to be welded 11 and 12, whereby the members 11 and 12 are softened by the frictional heat while maintaining solid phases thereof, thereby leading plastic flow promotion. In addition, at the time of the rotation of the welding tool 13, the probe portion 23 is inserted between the abutment surfaces 18 of the members to be welded 11 and 12 to thereby soften the members 11 and 12 by the frictional heat while the solid phases thereof being maintained. The probe portion 23 thus causes a plastic flow of the members to be welded 11 and 12, leading to further stirring.

Here, assuming that a diameter of the shoulder portion 22 of the welding tool 13 is “A” and that a length of the probe portion 23 is “B”, a width “C” (FIG. 4) and a thickness “D” (FIG. 3) of the margin portions 14 provided in an extended manner to the members to be welded 11 and 12 are respectively set to:

1.2×A≦C<2×A; and

1.2×B≦D<2×B.

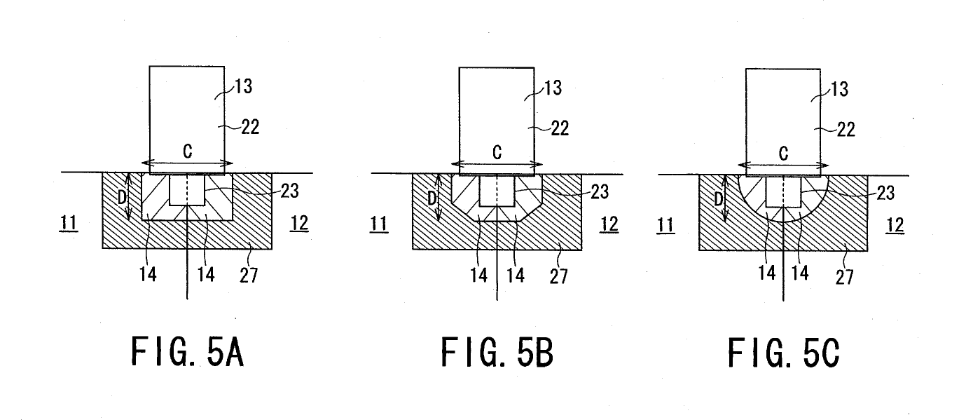

Further, the cross-sectional shapes of the margin portions 14 may be set to such a rectangular shape of the width “C”×the thickness “D” as illustrated in FIG. 5A, and this rectangular shape may be chamfered as illustrated in FIG. 5B. Alternatively, the cross-sectional shapes of the margin portions 14 may be set to a semicircular shape (C=2×D) having a diameter corresponding to the width “C”. In one disclosed embodiment, the cross-sectional shape of the margin portions 14 is the semicircular shape having the diameter corresponding to the width “C” of the margin portions 14.

In the friction stir welding, as illustrated in FIG. 1, the abutment surfaces 18 of the pair of prepared members to be welded 11 and 12 are brought into contact with each other, and the welding surfaces 20 of the margin portions 14 of the members 11 and 12 are brought into contact with each other, whereby the members 11 and 12 are held so as to abut against each other such that a continuous welding line 24 is formed therebetween. The contacted abutment surfaces 18 and the contacted welding surfaces 20 may be in close contact with each other without any gap, in order to prevent the occurrence of a defect in a friction stir welding portion 25 shown in FIG. 3 and FIG. 4.

In this state, as illustrated in FIG. 3, a load supporting jig portion 27 (a portion 27 of a jig for supporting a load to be applied thereto) is set on the bottom surface 26 side of the pair of margin portions 14, and a deformation restricting jig portion 28 (a portion 28 of the jig for restricting deformation thereof) is set on the top surface 21 side of the pair of margin portions 14.

The deformation restricting jig portion 28 protrudes integrally from the load supporting jig portion 27 or is integrated with the load supporting jig portion 27 by means of welding, by a fastener, or by the other suitable method to protrude therefrom, in parallel to the top surfaces 21 of the margin portions 14. The load supporting jig portion 27 and the deformation restricting jig portion 28 constitute the welding jig 15.

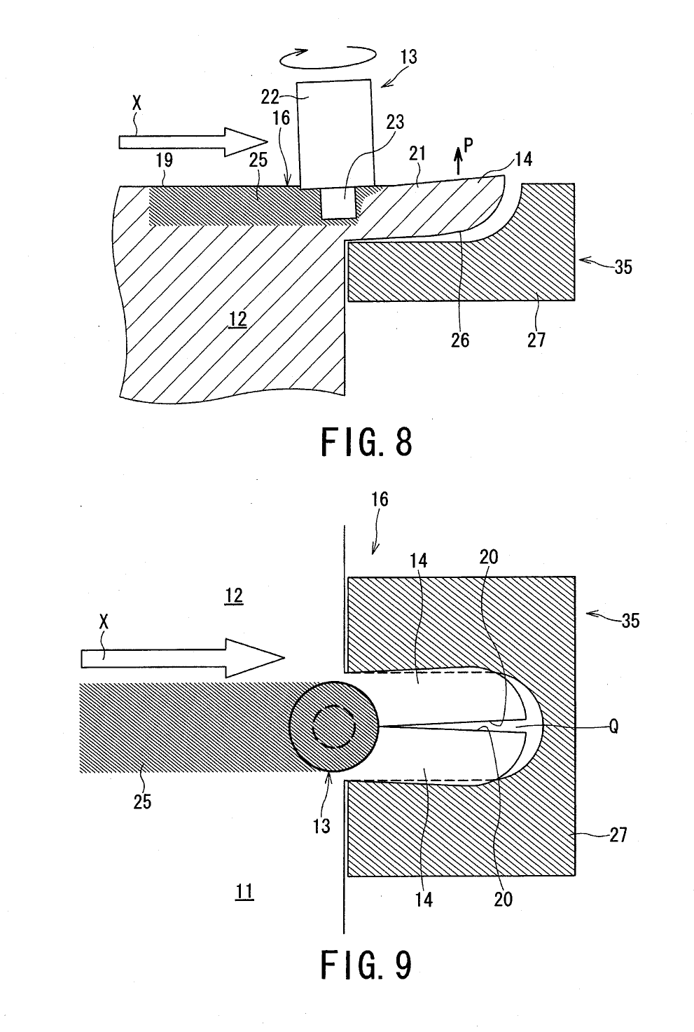

The load supporting jig portion 27 acts to support a pressing load that is applied by the welding tool 13 to the margin portions 14 at the time of performing the friction stir welding, and the margin portions 14 can be downsized by providing the load supporting jig portion 27. The deformation restricting jig portion 28 acts to restrict the deformations of the margin portions 14 toward the top surfaces 21 (that is, as illustrated in FIG. 8 and FIG. 9, an uplifting deformation of the margin portions 14 and an associated opening deformation of the welding surfaces 20 of the margin portions 14). The deformations are caused by: the softening of the margin portions 14 by the frictional heat with the welding tool 13; and the pressing load applied by the welding tool 13, at the time of the friction stir welding.

As illustrated in FIG. 3 and FIG. 4, the deformation restricting jig portion 28 is set at a position at which the deformation restricting jig portion 28 does not interfere with the welding tool 13 at the time of the friction stir welding, for example, at a position at which the deformation restricting jig portion 28 can abut against leading ends of the top surfaces 21 of the margin portions 14.

Thereafter, the welding tool 13 is pressed against the top surfaces 19 of the members to be welded 11 and 12 while being rotated, and the welding tool 13 is moved along the welding line 24 until the welding tool 13 reaches the margin portions 14, whereby the pair of members 11 and 12 are joined to each other and the pair of margin portions 14 are joined to each other by the friction stir welding.

In an actual operation, the welding tool 13 starts to be rotated at a position apart from the top surfaces 19 of the members 11 and 12 and the top surfaces 21 of the margin portions 14, and the rotating welding tool 13 is pressed against the welding line 24 between the margin portions 14 at one end corresponding to, for example, a welding start point. The probe portion 23 of the rotating welding tool 13 is then inserted between the welding surfaces 20 of the margin portions 14, and the leading end surface 22A of the shoulder portion 22 is pressed against the top surfaces 21 of the margin portions 14. In this state, the welding tool 13 is moved along the welding line 24 while being rotated, until the welding tool 13 reaches the margin portions 14 at another end corresponding to a welding end point. In this way, the friction stir welding is performed.

Through such friction stir welding as described above, the members to be welded 11 and 12 and the margin portions 14 are softened by the frictional heat with the welding tool 13 while maintaining the solid phases thereof, plastically flow to be stirred, and the friction stir welding portion 25 is then formed, thus finally obtaining the welded body 16 is obtained.

At the time of the friction stir welding, the pressing load that is applied by the welding tool 13 to the margin portions 14 is supported by the load supporting jig portion 27 of the welding jig 15.

Further, the deformations of the margin portions 14 toward the top surfaces 21 (the uplifting deformation of the margin portions 14 and the associated opening deformation of the welding surfaces 20 of the margin portions 14) are restricted and prevented by the deformation restricting jig portion 28, which abuts against the leading ends of the top surfaces 21 of the margin portions 14. The deformations are caused by the softening of the margin portions 14 and the pressing load.

After the friction stir welding, the margin portions 14 are cut off from the obtained welded body 16 along a cut line 30 (FIG. 3) to thereby obtain the product 17 illustrated in FIG. 6. A small-area margin cutoff surface 32 is formed on an end surface of the product 17 together with a cut surface 33 of the friction stir welding portion 25. A probe hole 34, shown in FIG. 3 or FIG. 13, remaining at the end point of the friction stir welding still exists in the margin portions 14. However, because the margin portions 14 are cut off, the probe hole 34 does not remain in the product 17.

Hereunder, an example of the friction stir welding according to one disclosed embodiment will be described.

In this example, the members to be welded 11 and 12 are each made of an aluminum alloy (A6061), and the margin portion 14 is formed through mechanical processing integrally with each of the members to be welded 11 and 12.

Dimensions of the margin portions 14 are set as shown in FIG. 7. That is, for example, the width “C” is 14.4 mm, the thickness “D” is 7.2 mm, and the length is 11 mm.

The welding tool 13 is made of alloy tool steel (SKD61), and the dimensions of the welding tool 13 are set as shown in FIG. 7. That is, for example, the diameter “A” of the shoulder portion 22 is 12 mm, the diameter of the probe portion 23 is 6 mm, and the length “B” of the probe portion 23 is 6 mm. Conditions for the use of the welding tool 13 at the time of the friction stir welding are set as shown in FIG. 7. That is, a rotation speed thereof is 800 rpm, and a feeding speed thereof is 150 mm/minute.

For the following two cases, the friction stir welding was performed under the same welding conditions shown in FIG. 7, and results of the friction stir welding thus performed were compared between the two cases. In the first case, the welding jig 15 including the load supporting jig portion 27 and the deformation restricting jig portion 28 was used at the time of the friction stir welding. In the second case, a welding jig 35 illustrated in FIG. 8 and FIG. 9 was used at the time of the friction stir welding, the welding jig 35 including only the load supporting jig portion 27 and not including the deformation restricting jig portion 28.

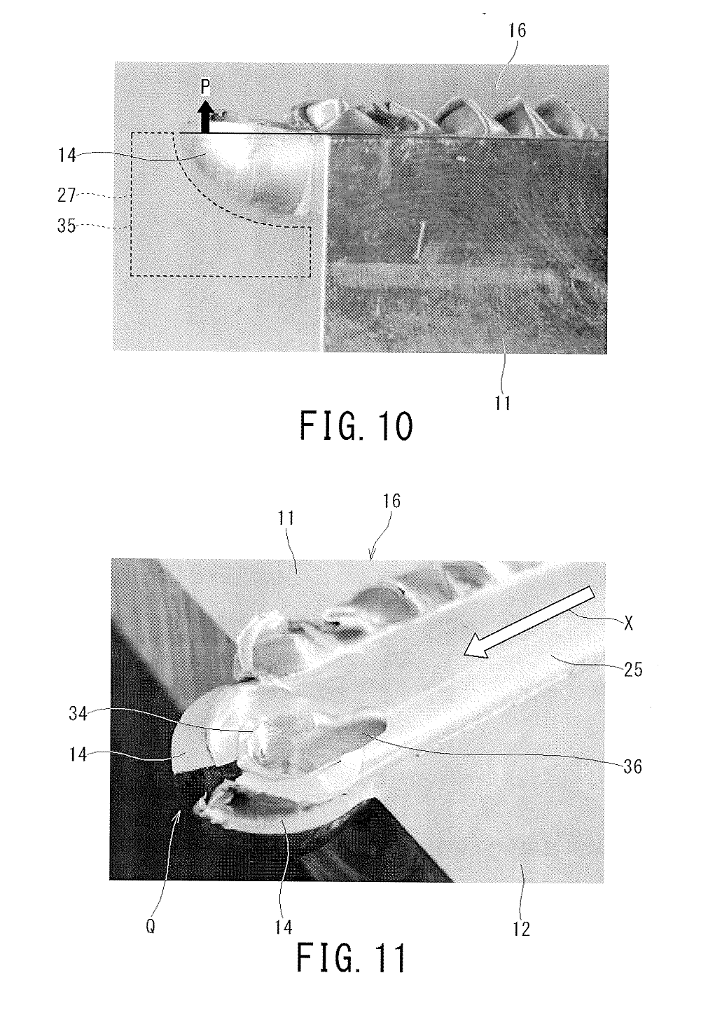

In the friction stir welding using the welding jig 35, as illustrated in FIG. 10 and FIG. 11, the margin portions 14 were uplifted toward the top surfaces 21 (as indicated by an arrow “P” in FIG. 8 and FIG. 10), and an associated opening “Q” (FIG. 9, FIG. 11) of the welding surfaces 20 of the margin portions 14 occurred, due to the pressing load that was applied by the welding tool 13 to the margin portions 14 and the softening of the margin portions 14 at the time of the friction stir welding. When the welding tool 13 was rotated near the opening “Q” of the margin portions 14, as illustrated in FIG. 11, a hole-shaped defect 36 occurred in the welded body 16 due to lack in material.

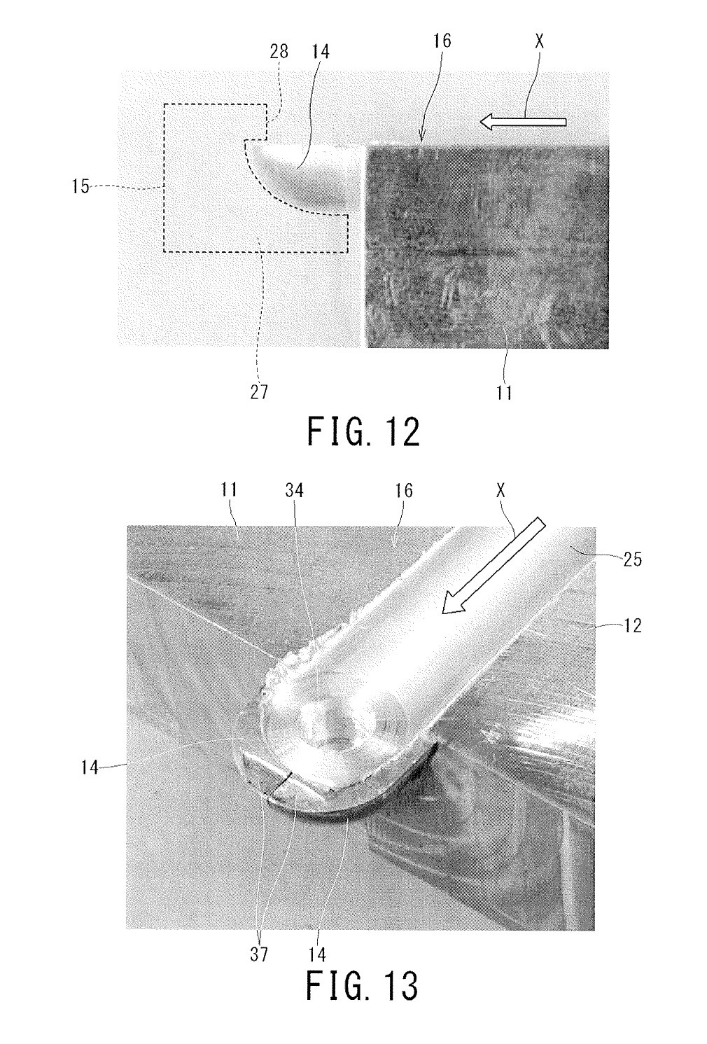

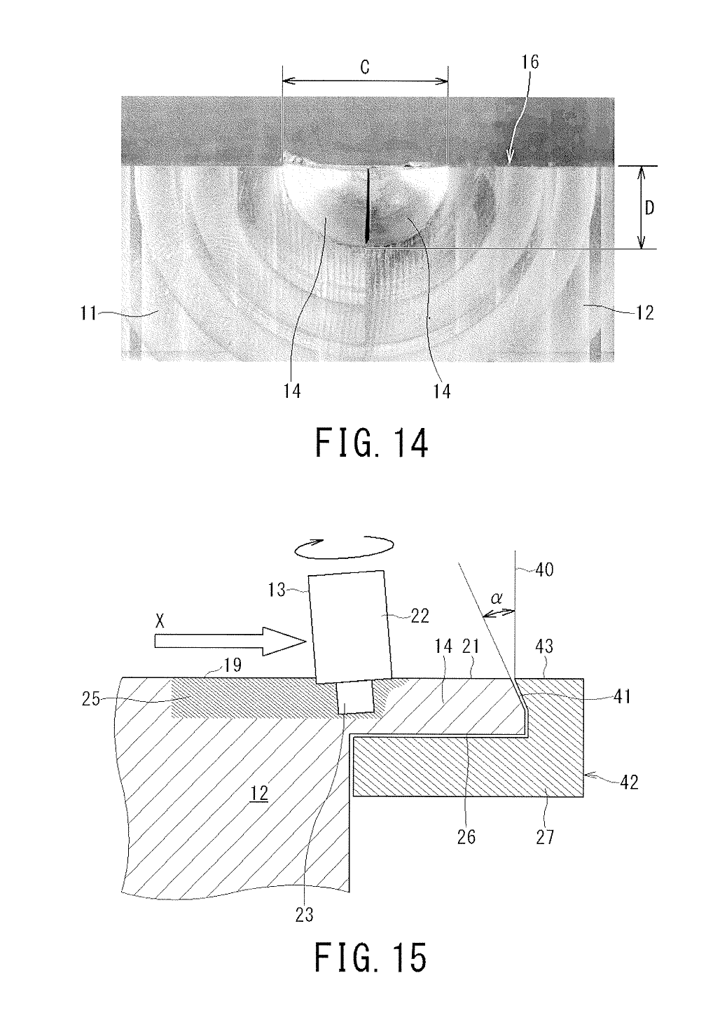

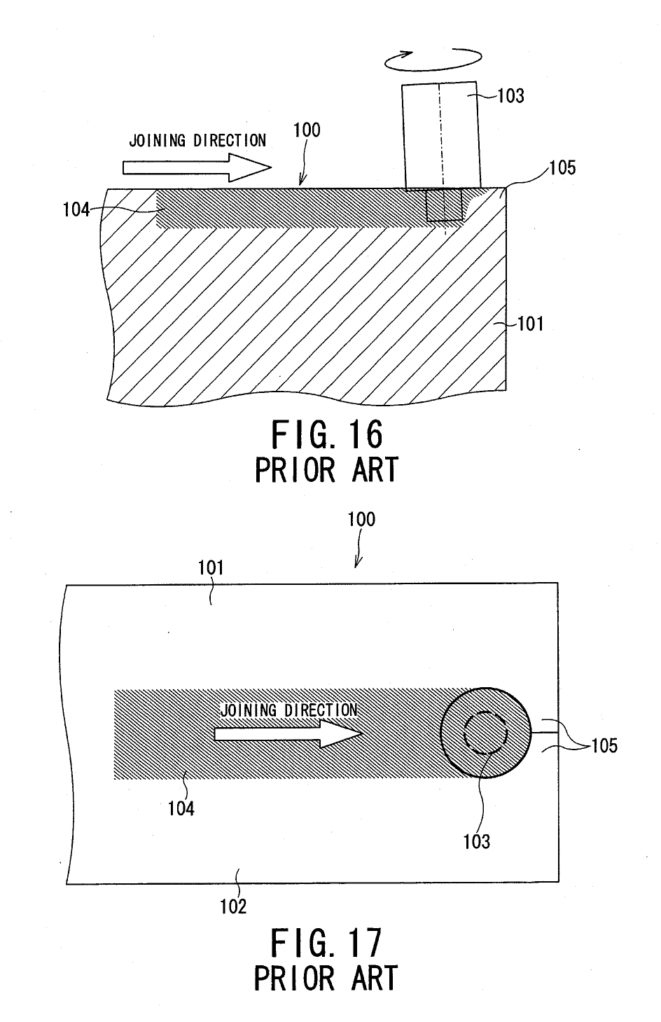

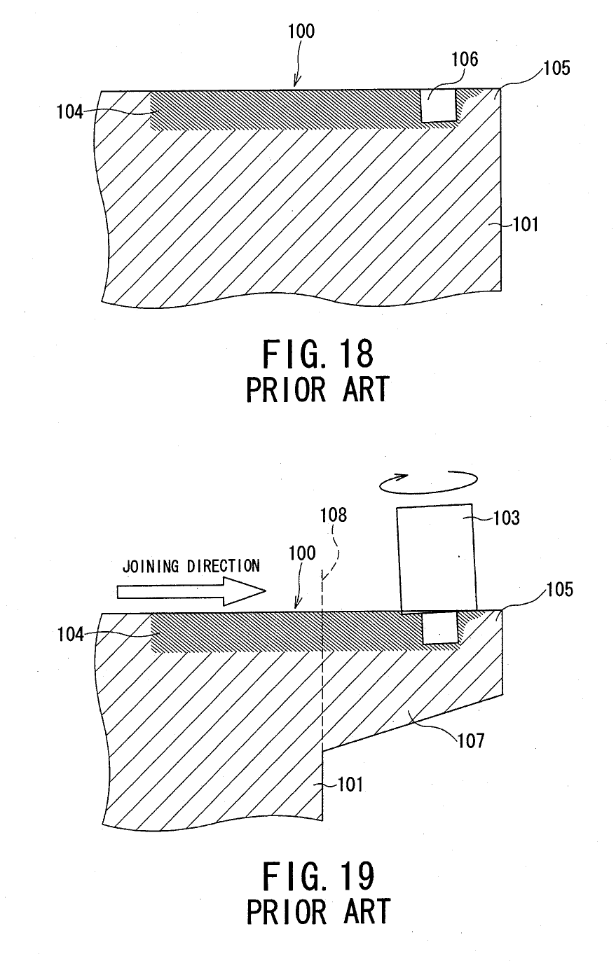

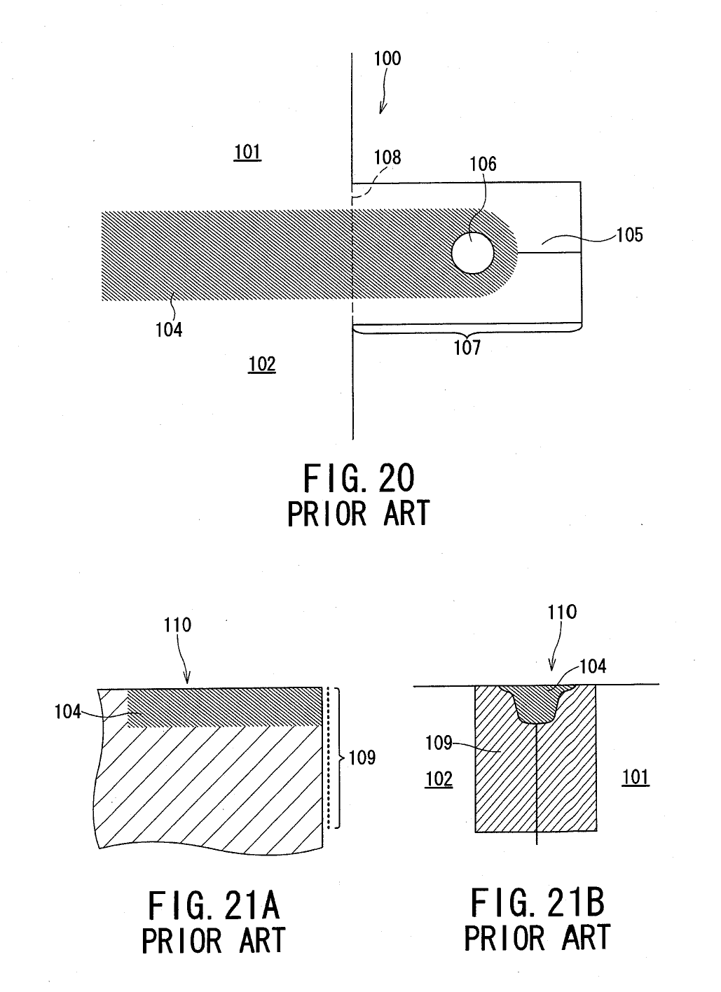

In contrast, in the friction stir welding using the welding jig 15 including the load supporting jig portion 27 and the deformation restricting jig portion 28, as illustrated in FIG. 12 to FIG. 14, the leading ends of the top surfaces 21 of the margin portions 14 (in this example, in a range of 2.5 mm from the top surfaces of the margin portions 14) were restricted by the deformation restricting jig portion 28. Hence, the margin portions 14 were not uplifted at the time of the friction stir welding, and accordingly, the opening of the welding surfaces 20 of the margin portions 14 did not occur. As a result, although the probe hole 34 formed by the shoulder portion 22 of the welding tool 13 remained in the margin portions 14, the defect 36 did not occur in the welded body 16, and hence, it was found that the excellent welding was achieved.

It is further to be noted that an arrow X in FIG. 11 to FIG. 13 indicates a moving direction of the welding tool 13 at the time of the friction stir welding. Reference numeral 37 in FIG. 13 denotes an abutment trace that is marked on the margin portions 14 by the deformation restricting jig portion 28.

The disclosed embodiment having such structures and characteristic features as described above produces the following advantageous effects (1) to (4).

As illustrated in FIG. 3 and FIG. 4, the welding tool 13 is pressed and moved along the welding line 24 (FIG. 1) between the members to be welded 11 and 12 and between the margin portions 14 while being rotated. The members to be welded 11 and 12 are thereby joined to each other and the margin portions 14 are also joined to each other by the friction stir welding. On this occasion, the load supporting jig portion 27 of the welding jig 15, which is set on the bottom surface 26 side of the margin portions 14, supports the pressing load applied by the welding tool 13 to the margin portions 14. As a result, cross-sectional areas of the margin portions 14 can be reduced, and the margin portions 14 can be thus downsized, so that the margin cutoff surface 32 (FIG. 6) formed by cutting off the margin portions 14 can be made small. Accordingly, the quality of the external appearance of the product 17 can be enhanced.

Similarly, the welding tool 13 is pressed and moved along the welding line 24 between the members to be welded 11 and 12 and between the margin portions 14 while being rotated, whereby the members to be welded 11 and 12 are joined to each other and the margin portions 14 are also joined to each other by the friction stir welding. On this occasion, the deformation restricting jig portion 28 of the welding jig 15 restricts the deformations of the margin portions 14 toward the top surfaces 21, that is, the uplifting deformation of the margin portions 14 and the associated opening deformation of the welding surfaces 20 of the margin portions 14. As a result, lack in material due to the opening deformation of the welding surfaces 20 of the margin portions 14 can be avoided, and accordingly, a welding failure of the members 11 and 12 due to the deformations of the margin portions 14 (i.e., the occurrence of the defect 36 illustrated in FIG. 11) can be reliably prevented.

As illustrated in FIG. 2 to FIG. 4, assuming that the diameter of the shoulder portion 22 of the welding tool 13 is “A” and that the length of the probe portion 23 is “B”, the width “C” and the thickness “D” of the margin portions 14 of the members to be welded 11 and 12 are respectively set to: C <2×A; and D<2×B. Hence, the margin portions 14 can be downsized, so that the margin cutoff surface 32 (FIG. 6) can be made smaller. Accordingly, the quality of the external appearance of the product 17 can be enhanced. In addition, the width “C” and the thickness “D” are respectively set to: 1.2×A≦C; and 1.2×B≦D. Hence, interference between the welding tool and the welding jig can be prevented, and the rigidity of the margin portions 14 required at the time of the friction stir welding can be secured. Accordingly, the deformations of the margin portions 14 can be efficiently suppressed, and the occurrence of the defect 36 (FIG. 11) can be effectively prevented.

As illustrated in FIG. 5C and FIGS. 6A and 6B, the cross-sectional shapes of the margin portions 14 are set to the semicircular shape having the diameter corresponding to the width “C” of the margin portions 14. Hence, the margin portions 14 can be further downsized, thus also minimizing the margin cutoff surface 32. Accordingly, the quality of the external appearance of the product 17 can be enhanced.

It is further to be noted that the present invention is not limited to the disclosed embodiments, and many other changes and modifications or alternations may be made without departing from the scope of the appended claims.

For example, as illustrated in FIG. 15, a tapered surface 41 may be formed at the leading end of each margin portion 14 so as to be tilted by an inclination angle α to a virtual plane 40 orthogonal to the top surface 21. Then, a deformation restricting jig portion 43 of a welding jig 42 may be formed so as to be tilted by the inclination angle α correspondingly to the tapered surface 41 such that the deformation restricting jig portion 43 can abut against the tapered surface 41 at the time of the friction stir welding. In this example, the inclination angle α may be set to, for example, 15 degrees or more.

What is claimed is:

1. A friction stir welding method, comprising:
preparing a pair of members to be welded each including an abutment surface and a margin portion provided in an extended manner, the margin portion including a welding surface that is continuous to the abutment surface;
preparing a welding tool for performing friction stir welding, the welding tool integrally including a columnar shoulder portion and a probe portion formed on a leading end surface of the shoulder portion, the probe portion having a diameter smaller than a diameter of the shoulder portion;
bringing the abutment surfaces into contact with each other, bringing the welding surfaces into contact with each other, and holding the members to be welded so as to form a continuous welding line therebetween;
setting, under the state, a load supporting jig portion on a bottom surface side of a pair of the margin portions while setting a deformation restricting jig portion on a top surface side of the pair of margin portions, the load supporting jig portion supporting a pressing load applied by the welding tool, the deformation restricting jig portion restricting deformations of the margin portions toward the top surfaces thereof; and
pressing the welding tool against top surfaces of the members to be welded while rotating the welding tool, and moving the welding tool along the welding line until the welding tool reaches the margin portions to thereby join the members to be welded to each other and join the margin portions to each other by the friction stir welding.

2. The friction stir welding method according to claim 1, wherein assuming that the diameter of the shoulder portion of the welding tool is A, a width C of the margin portions is set so as to satisfy the following equation:
1. 2×A≦C<2×A.

3. The friction stir welding method according to claim 1, wherein assuming that a length of the probe portion of the welding tool is B, a thickness D of the margin portions is set so as to satisfy the following equation:
1. 2×B≦D<2×B.

4. The friction stir welding method according to claim 1, wherein the margin portions are set to have a semicircular shape, when welded, having a diameter corresponding to a width of the margin portions.

5. A welding jig used for a friction stir welding method, the friction stir welding method including: preparing a pair of members to be welded each including an abutment surface and a margin portion provided in an extended manner, the margin portion including a welding surface that is continuous to the abutment surface; preparing a welding tool for performing friction stir welding, the welding tool integrally including a columnar shoulder portion and a probe portion formed on a leading end surface of the shoulder portion, the probe portion having a diameter smaller than a diameter of the shoulder portion; bringing the abutment surfaces into contact with each other, bringing the welding surfaces into contact with each other, and holding the members to be welded so as to form a continuous welding line therebetween; and pressing a welding tool against top surfaces of the held members to be welded while rotating the welding tool, and moving the welding tool along the welding line until the welding tool reaches the margin portions to thereby join the members to be welded to each other and join the margin portions to each other,
the welding jig comprising:
a load supporting jig portion; and
a deformation restricting jig portion,
wherein the load supporting jig portion is set on a bottom surface side of a pair of the margin portions for supporting a pressing load applied by the welding tool, and the deformation restricting jig portion is set to on a top surface side of the pair of margin portions for restricting deformations of the margin portions toward the top surfaces thereof.

6. The welding jig according to claim 5, wherein the deformation restricting jig portion is provided to the load supporting jig portion so as to abut against leading ends of the top surfaces of the margin portions.
